(19) United States
(12) Patent Application Publication
(10) Pub. No.: US 2005/0063350 A1
(43) Pub. Date: Mar. 24, 2005

(54) Method of supporting mobility and session persistence across subnets in wired and wireless LANs

(76) Inventors: Abhijit K. Choudhury, Cupertino, CA (US); Mathew Kayalackakom, Cupertino, CA (US); Shekhar Ambe, San Jose, CA (US); Ken C. K. Chin, Saratoga, CA (US)

Correspondence Address: Pillsbury Winthrop LLP;Intellectual Property Group, Suite 200, 11682 El Camino Real, San Diego, CA, 92130-2092, US

(21) Appl. No.: 10/884,365

(22) Filed: Jul. 2, 2004

Related U.S. Application Data
(60) Provisional application No. 60/484,979, filed on Jul. 3, 2003.

(51) Int. Cl. H04L 12/56; H04Q 7/24

(52) U.S. Cl. 370/338; 370/352; 370/400

(57) ABSTRACT

An apparatus provides a hardware-based solution to enable roaming with session persistence within or between subnets. In accordance with a further aspect of the invention, one approach described herein is based on NAT/NAPT, while another uses aspects of Mobile IP. The architecture involved in both hardware approaches is such that it is scalable for implementation in a variety networking products that fulfill enterprise security and all possible combinations of wired and wireless networking needs, such as access points, access point concentrators, wireless-ready wiring closet or edge switches, and wireless co-processors.

### CROSS-REFERENCE TO RELATED APPLICATIONS

The present application claims priority to provisional application 60/484,979, filed on Jul. 3, 2003.

### FIELD OF THE INVENTION

Aspects of the present invention relate generally to network communications, and more particularly, to wired and wireless networks and architectures.

### BACKGROUND

The Wireless Local Area Network (WLAN) market has recently experienced rapid growth, primarily driven by consumer demand for home networking. The next phase of the growth will likely come from the commercial segment, such as enterprises, service provider networks in public places (Hotspots), multi-tenant, multi-dwelling units (MxUs) and small office home office (SOHOs). The worldwide market for the commercial segment is expected to grow from 5M units in 2001 to over 33M units in 2006. However, this growth can be realized only if the issues of security, service quality and user experience are addressed effectively in newer products.

FIG. 1 illustrates possible wireless network topologies. As shown in FIG. 1, a wireless network 100 typically includes at least one access point 102, to which wireless-capable devices such as desktop computers, laptop computers, PDAs, cell phones, etc. can connect via wireless protocols such as 802.11a/b/g. Several or more access points 102 can be further connected to an access point controller 104. Switch 106 can be connected to multiple access points 102, access point controllers 104, or other wired and/or wireless network elements such as switches, bridges, computers, and servers. Switch 106 can further provide an uplink to another network. Many possible alternative topologies are possible, and this figure is intended to illuminate, rather than limit, the present inventions.

One important issue with respect to wireless networking is the problem of Roaming and Session Persistence. Roaming allows the user to move from one network to another, across same networks or across subnets. The user may do this intentionally to utilize a better or faster connection through a different Access Point or because user location has changed. Assuming that the user is originally authenticated while roaming user authentication across a WLAN should be transparent. The user should not require any manual action or any special application. There should be no reconfiguration needed when the user changes from one subnet to another. Any reconfiguration necessary should be done automatically. When roaming across subnets the WLAN user will encounter a problem with DHCP. As client changes network the new DHCP-server will provide a new IP-address. This will result in a break in an ongoing connection/session.

“Session persistence” means more than forwarding packets to a user's new location. “Persistence” can refer to just the problem of having packets forwarded as users roam among subnets, coverage areas and network types (wired LANs, wireless LANs and wireless WANs). More generally, it should refer to transport and application session persistence because when a transport protocol cannot communicate to its peer, the underlying protocols, like TCP, assume that the disruption of service is due to network congestion. When this occurs these protocols back off, reducing performance and eventually terminating the connection. WLAN networks have coverage holes causing dropouts even with access point overlap. This impacts a mobile device's range of mobility.

There is currently no acceptable solution for wireless roaming and session persistence across subnets in wireless LANs. Mobile IP is one attempted solution, but it is implemented entirely in software.

IEEE has proposed Inter-Access Point Protocol (IAPP) in the draft form (IEEE 802.11f) which will become the standard in the foreseeable future. IAPP is a protocol used by the management entity of an AP to communicate with other APs, when various events related to roaming occur in the AP. The main functions of the IAPP are:
1. It facilitates the creation and maintenance of the Extended Service Set (ESS) in a WLAN network.
2. It supports station mobility, also called roaming.
3. It enables the APs to enforce a single association for each mobile station at a given time.
4. It removes the need for re-authentication with the RADIUS server when moving between APs, thus reducing the load on RADIUS server.
5. It makes the session user friendly by enabling seamless connectivity.

When a WLAN client roams and associates with a new AP, IAPP can be used to exchange the context of the current session between the APs. However, IAPP, as defined by the IEEE in 802.11 f, does not cover the scenarios where the station roams from one AP to another AP that is attached to a different subnet. The messages exchanged in IAPP are confined to a single subnet and cannot be used to transfer context between APs that are attached to different subnets.

Meanwhile, many WLAN vendors are integrating combined 802.11a/g/b standards into their chipsets. Such chipsets are targeted for what are called Combo-Access Points which will allow users associated with the Access Points to share 100 Mbits of bandwidth in Normal Mode and up to ˜300 Mbits in Turbo Mode. The table below shows why a software roaming solution without hardware acceleration is not feasible when bandwidth/speeds exceed 100 Mbits.

| | | Required | | |
|---|---|---|---|---|
| | | Processor Speed | | |
| Interface | | [MHz] | | CPU |
| | BW | | IPSec + | Subsyst |
| Type | [Mbs] | IPSec | Other | Cost |
| DSL | 1-5 | 133 | 200+ | |
| Ether | 10 | 300 | 500+ | |
| 802.11a | 30-50 | 1200 | 1500+ | $400 |
| | | | | [2002] |
| | | | | $125 |
| | | | | [2004] |
| Fast | 100 | 2500 | 3000+ | $600 |
| Ether | | | | [2002] |
| | | | | $250 |
| | | | | [2004] |

| | | |
|---|---|---|
| Multiple | 500 | Not Feasible in Software |
| FE | | Needs Dedicated Hardware |
| Gigabit | 1000 | |
| Ether | | |

Although infrastructures for wired networks have been highly developed, the above and other problems of wireless networks are comparatively less addressed. Meanwhile, there is a need to address situations where enterprises and/or networks may have any combination of both wired and wireless components.

### SUMMARY

Embodiments of the present invention relate generally to a single-chip solution that addresses current weaknesses in wireless networks, but yet is scalable for a multitude of possible wired and/or wireless implementations. Current solutions to resolve/overcome the weaknesses of WLAN are only available in the form of Software or System implementations. These resolve only specific WLAN problems and they do not address all of the existing limitations of wireless networks.

In accordance with an aspect of the invention, an apparatus may provide a hardware-based solution to enable roaming between subnets. In accordance with a further aspect of the invention, one approach described herein is based on NAT/NAPT, while another uses aspects of Mobile IP. The architecture involved in both hardware approaches is such that it is scalable for implementation in a variety networking products that fulfill enterprise security and all possible combinations of wired and wireless networking needs, such as access points, access point concentrators, wireless-ready wiring closet or edge switches, and wireless co-processors.

### BRIEF DESCRIPTION OF THE DRAWINGS

These and other aspects and features of the present invention will become apparent to those ordinarily skilled in the art upon review of the following description of specific embodiments of the invention in conjunction with the accompanying figures, wherein:

FIG. 1 illustrates wireless network topologies;

FIG. 2 is a block diagram illustrating a wired and wireless network device architecture in accordance with an embodiment of the present invention;

FIG. 3 illustrates roaming features based on the Mobile IP protocol implemented in hardware and firmware by a network device such as that illustrated in FIG. 2;

FIG. 4 is a block diagram illustrating operation of the NAPT protocol; and

FIG. 5 is a block diagram illustrating roaming features implemented in hardware and firmware by a network device such as that illustrated in FIG. 2 in accordance with the NAPT protocol.

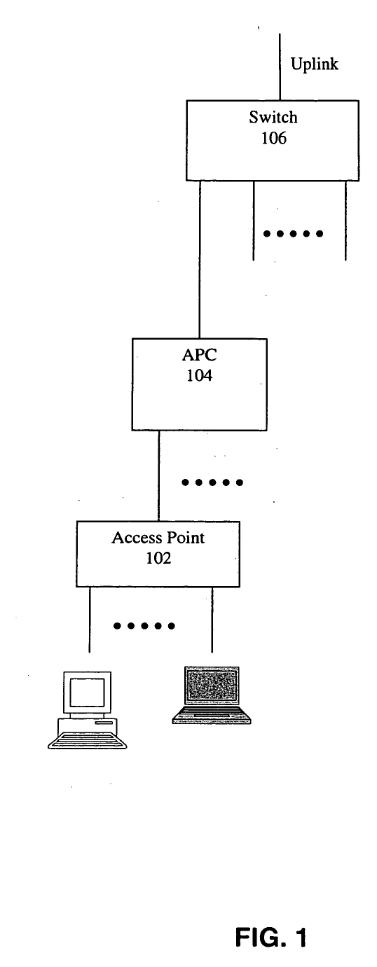

### DETAILED DESCRIPTION

Embodiments of the present invention deliver a hardware network device and solution to solve wireless LAN roaming while maintaining session persistence with the application server while roaming within or across subnets. Such a device and solution should also be scalable to enable implementation in the various components and alternative topologies of wired and/or wireless networks, such as, for example, in an access point, an access point controller, or in a switch.

The present invention will now be described in detail with reference to the drawings, which are provided as illustrative examples of the invention so as to enable those skilled in the art to practice the invention. Notably, the figures and examples below are not meant to limit the scope of the present invention. Moreover, where certain elements of the embodiments of the present invention can be partially or fully implemented using known components, only those portions of such known components that are necessary for an understanding of the embodiments will be described, and detailed descriptions of other portions of such known components will be omitted so as not to obscure the invention. Still further, aspects of the present invention encompasses present and future known equivalents to the known components referred to herein by way of illustration, and implementations including such equivalents are to be considered alternative embodiments of the invention.

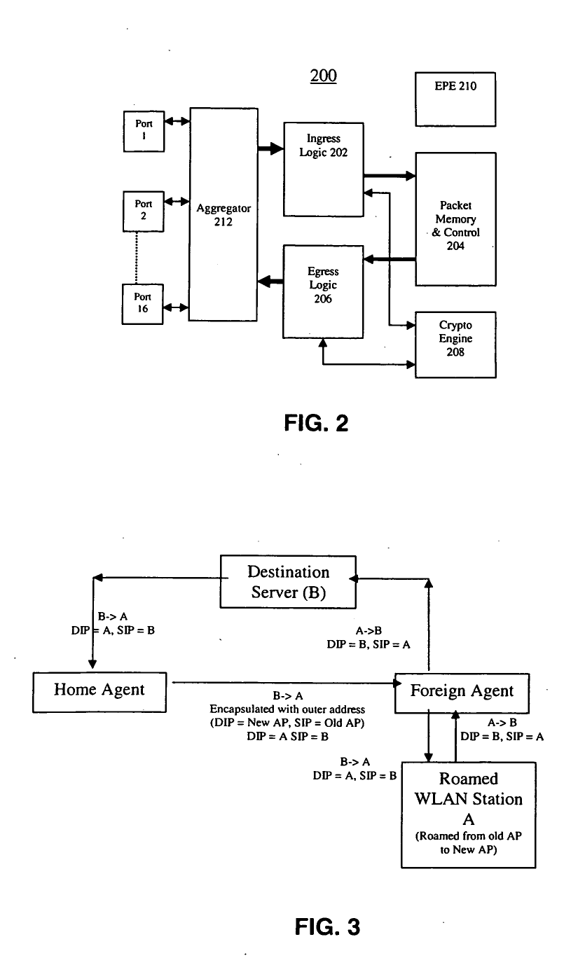

FIG. 2 is a block diagram illustrating an example of a single-chip wired and wireless network device 200 that can implement the roaming and session persistence solutions of an embodiment of the present invention. As shown in FIG. 2, chip 200 includes ingress logic 202, packet memory and control 204, egress logic 206, crypto engine 208, an embedded processor engine 210 and an aggregator 212. Co-pending application Ser. No.______(Atty. Dkt. 79202-309844; SNT-001) describes the device 200 in more detail and its contents are incorporated herein by reference.

The wired and wireless network device 200 according to the embodiment of the present invention can support two approaches to enable roaming between subnets. The first approach described herein uses Mobile IP.

In one example implementation of the present invention, Mobile IP is supported by hardware in the ingress and egress paths 202 and 206, as well as by firmware running on the embedded processor engine 210.

The Mobile IP protocol uses an address-forwarding mechanism to deliver packets to the roaming station as it roams from one subnet to another. Mobile IP provides users the freedom to roam beyond their home subnets while maintaining their home IP addresses. This enables transparent routing of IP packets to mobile users during their movement, so that data sessions can be initiated to them while they roam. For example, a client device with an IP address of 192.95.5.2 could associate to an access point on a foreign network whose IP addresses are in the 209.165.200.x range. The guest client device keeps its 192.95.5.2 IP address, and continues to receive packets destined to it with the help of Mobile IP-enabled routers on the client's home and foreign networks.

In Mobile IP, packets are routed to a roaming station with the help of the Home Agent and the Foreign Agent. This is further illustrated in FIG. 3.

Home Agent: The Home Agent resides within the mobile station's home subnet. The function of the Home Agent is to intercept the packets addressed to the roaming station and then forward the packet to the Foreign Agent, which can deliver the packet to the roaming station.

Foreign Agent: The Foreign Agent receives the packets from Home Agent and delivers it to roaming station.

Mobility agents (i.e., Foreign Agents and Home Agents) advertise their presence via Agent Advertisement messages. A mobile node may optionally solicit an Agent Advertisement message from any locally attached mobility agents through an Agent Solicitation message. A mobile node receives these Agent Advertisements and determines whether it is on its home network or a foreign network.

When the mobile node detects that it is located on its home network, it operates without mobility services. If returning to its home network from being registered elsewhere, the mobile node deregisters with its Home Agent, through exchange of a Registration Request and Registration Reply message with it.

When a mobile node detects that it has moved to a foreign network, it obtains a care-of address on the foreign network from a Foreign Agent's advertisements. The mobile node operating away from home then registers its new care-of address with its Home Agent through exchange of a Registration Request and Registration Reply message with it, via a Foreign Agent.

Packets sent to the mobile node's home address are intercepted by its Home Agent, tunneled by the Home Agent to the mobile node's care-of address, received at the tunnel endpoint at the Foreign Agent, and finally delivered to the mobile node. In the reverse direction, packets sent by the mobile node are generally delivered to their destination using standard IP routing mechanisms, not necessarily passing through the Home Agent.

The wired and wireless network device 200 supports roaming using Mobile IP by allowing IP-in-IP tunneling. The ARP Table is used for doing the IP-in-IP tunneling. If the destination IP address lookup in the ARP table indicates that a tunnel has to be set to forward the packet to the destination then it uses the IPAddressIndex field from the ARP entry to get the outer header Destination IP address. The new IP address is obtained by looking up the location in the ARP table pointed to by the IP-AddressIndex. The packet is forwarded based on an ARP Table lookup using the Outer_Dest_IP field. The outer header for the tunneled packet is created using the Outer_Dest_IP, the Outer_Src_IP and the relevant fields from the inner header.

The wired and wireless network device 200 according to the embodiment of the present invention can also support roaming between subnets using another approach based on an innovative use of Network Address Port Translation (NAPT). In one example implementation of the present invention, network address port translation is supported by hardware in the ingress and egress paths 202 and 206, as well as by firmware running on the embedded processor engine 210.

As is known, Network Address Translation (NAT) is a method by which IP Addresses are mapped from one addressing realm to another, providing transparent routing to end hosts. Traditionally, NAT is used to connect an isolated addressing realm with private unregistered addresses to an external addressing realm with globally registered addresses. Network Address Port Translation (NAPT) extends the notion of translation one step further by also translating the transport identifiers (e.g., TCP/UDP port numbers, ICMP query identifiers). This allows the transport identifiers of multiple private hosts to be multiplexed onto the transport identifiers of a single external address. NAPT allows a set of hosts to share a single IP address or a small number of IP addresses. For packets outbound from the private network, NAPT would translate the source IP address, source transport identifier like the TCP/UDP port or ICMP query identifier, and related fields like the IP header checksum and the TCP/UDP/ICMP header checksum. For inbound packets, the destination IP address, destination transport identifier and the IP and transport header checksums would be modified.

A wired and wireless network device according to an embodiment of the present invention supports NAPT and also uses it in a novel way to support station mobility or roaming.

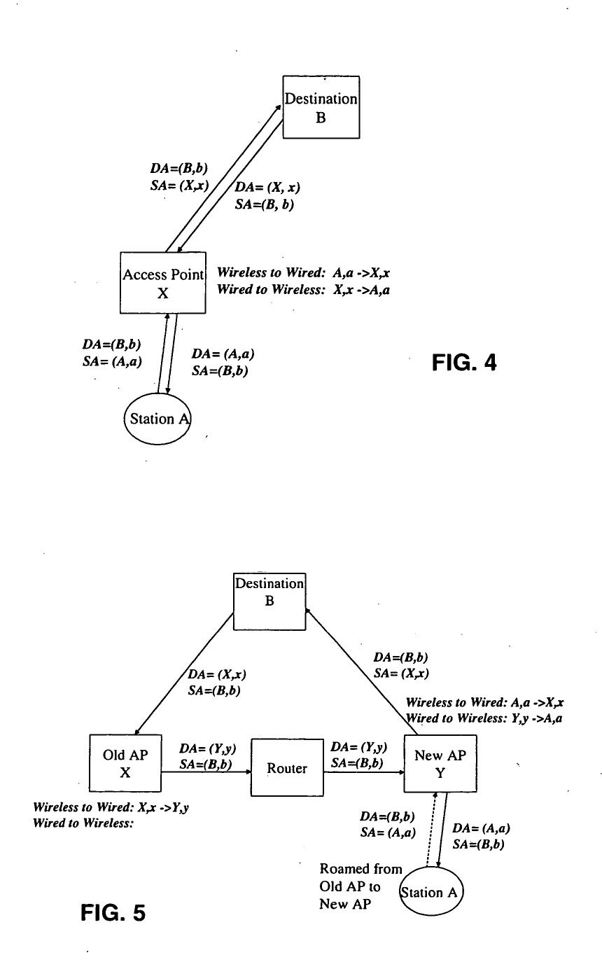

FIG. 4 illustrates mapping of IP address and port using the NAPT functionality between the wireless station A and the destination B. DA and SA stand for Destination Address-Port pair and Source Address-Port pair respectively. The tuple (A,a) denotes (IP Address=A, Port=a). As shown in FIG. 3, a wireless station A, that is associated with an AP labeled X, communicating with a destination B over a TCP or UDP connection. Let DA denote the (Destination IP Address, Destination Port) tuple while SA will denote the (Source IP Address, Source Port) tuple. When station A, with IP Address A, sets up a connection between its own Port a and Port b on destination B with an IP Address B, the outbound session from station A, as shown in the figure, uses DA=(B,b) and SA=(A,a). The NAPT function on the AP alters the SA used to (X,x). The destination B is only aware of a connection with DA=(B,b) and SA=(X,x) and so it sets up a return connection with DA=(X,x) and SA=(B,b). The NAPT function on the AP uses the reverse mapping to remap this connection to one with DA=(A,a) and SA=(B,b), there by enabling a bi-directional connection to be set up. This bi-directional address binding is stored in the AP and used to translate packets between station A and destination B. The AP alters the SA on every packet from the station A to destination B using the (A,a)->(X,x) mapping while in the reverse direction it uses the (X,x)->(A,a) mapping to alter the DA on the packets going from the server B to station A. Note that packets exchanged between two wireless stations do not need NAPT support, and the same holds for packets exchanged between two hosts on the wired domain.

FIG. 5 illustrates mapping of IP address and port between the roaming wireless station A and the destination B using the NAPT functionalities on the old AP and the new AP. DA and SA stand for Destination Address-Port pair and Source Address-Port pair respectively. The tuple (A,a) denotes (IP Address=A, Port=a). As shown in FIG. 5, when the station A roams and re-associates with a new AP labeled Y, any packet coming from the station A needs to use the same parameters so that re-authentication is not needed and the old connection can be retained. A higher-level protocol enables this by exchanging contexts between the old AP and the new AP. The new AP provides its own (Address, Port) tuple (Y,y) for the connection to the old AP. In return, it obtains the NATed (Address, Port) tuple (X,x) for the connection at the old AP as well as the context for the connection, including parameters like the Security Association and ALG state. Following this exchange, every packet from the roamed station A to destination B has its SA altered by the new AP from (A,a) to (X,x) and sent directly to B, so that destination B does not notice any difference in the connection. When the server B sends the packet back to the roaming station, the routers/switches will deliver the packet to the old AP with DA=(X,x) and SA=(B,b). The old AP modifies the DA using the (X,x)->(Y,y) mapping and sends the packets to the new AP. When new AP gets this packet, the DA is further modified using the (Y,y)->(A,a) mapping, so that station A receives the packet with DA=(A,a) and SA=(B,b).

Although the present invention has been particularly described with reference to the preferred embodiments thereof, it should be readily apparent to those of ordinary skill in the art that changes and modifications in the form and details may be made without departing from the spirit and scope of the invention. It is intended that the appended claims include such changes and modifications.

1. A roaming-agent apparatus with a home address associated with a home agent for application in a wired and/or wireless network comprising:
a scalable ingress path;
a scalable egress path;
an aggregator configured to receive packets from ports, configured to provide a stream for the ingress path, configured to receive a stream from the egress path, and configured to output packet data to the ports;
an embedded processor configured to detect a presence of a foreign agent via a foreign agent advertisement message, and configured to register a roaming care-of address with the home agent through exchange of a registration request via the foreign agent when the foreign agent is detected.

2. The apparatus of claim 1 wherein the embedded processor is further configured to use tunneling to hide an origin of the payload from intervening routers located between the home agent and the foreign agent.

3. The apparatus of claim 2 wherein tunneling is achieved through Internet Protocol-in-Internet Protocol tunneling.

4. The apparatus of claim 3 wherein the care-of address is an address to which packets can be delivered via Internet Protocol.

5. An method of roaming with a home address associated with a home agent for application in a wired and/or wireless network comprising:
receiving a packet stream via a scalable ingress path;
detecting a presence of a foreign agent via a foreign agent advertisement message within the packet stream received at the one or more ports;
register a roaming care-of address with the home agent through exchange of a registration request via the foreign agent when the foreign agent is detected; and
outputting the packet stream to the one or more ports via a scalable egress path.

6. The method of claim 5 further comprising:
using tunneling to hide the home address from intervening routers located between home agent and the foreign agent.

7. The method of claim 6 wherein tunneling is achieved through Internet Protocol-in-Internet Protocol tunneling.

8. The method of claim 7 wherein the care-of address is an address to which packets can be delivered via Internet Protocol.

9. An apparatus of roaming with a home address associated with a home agent for application in a wired and/or wireless network comprising:
means for receiving a packet stream via a scalable ingress path;
means for detecting a presence of a foreign agent via a foreign agent advertisement message within the packet stream received at the one or more ports;
means for register a roaming care-of address with the home agent through exchange of a registration request via the foreign agent when the foreign agent is detected; and
means for outputting the packet stream to the one or more ports via a scalable egress path.

10. The apparatus of claim 9 further comprising:
means for tunneling to hide the home address from intervening routers located between home agent and the foreign agent.

11. The apparatus of claim 10 wherein the tunneling is achieved through Internet Protocol-in-Internet Protocol tunneling.

12. The apparatus of claim 11 wherein the care-of address is an address to which packets can be delivered via Internet Protocol.

13. A computer-readable medium, encoded with data and instructions, such that when executed by a computer, the instructions causes the computer to:
receive a packet stream via a scalable ingress path;
detect a presence of a foreign agent via a foreign agent advertisement message within the packet stream received at one or more ports;
register a roaming care-of address with a home agent through exchange of a registration request via the foreign agent when the foreign agent is detected; and
output the packet stream to the one or more ports via a scalable egress path.

14. The computer-readable medium of claim 13, the instructions further comprising:
using tunneling to hide the home address from intervening routers located between home agent and the foreign agent.

15. The computer-readable medium of claim 14 wherein the tunneling is achieved through Internet Protocol-in-Internet Protocol tunneling.

16. The computer-readable medium of claim 15 wherein the care-of address is an address to which packets can be delivered via Internet Protocol.

17. An apparatus for application in a wired and/or wireless network comprising:
a scalable ingress path;
a scalable egress path;
an aggregator configured to receive packets from ports, configured to provide a stream for the ingress path, configured to receive a stream from the egress path, and configured to output packets to the ports;
an embedded processor configured to determine if the received packets or the output packet require transport identifier translation.

18. The apparatus of claim 17 wherein the embedded processor is further configured to translate the output packet when the output packet requires transport identifier translation.

19. The apparatus of claim 18 wherein the embedded processor is further configured to translate the received packet when the received packet requires transport identifier translation.

20. The apparatus of claim 19 wherein the transport identifier is an Internet Protocol address, Transmission Control Protocol port, User Datagram Protocol port, Internet Control Message Protocol query identifier, Internet Protocol header checksum, Transmission Control Protocol header checksum, or User Datagram Protocol header checksum.

21. An method of network address port translation comprising:
receiving a packet via a scalable ingress path;
determining whether the received packet requires transport identifier translation;
outputting the received packet stream to one or more ports via a scalable egress path.

22. The method of claim 21 further comprising:
translating an output packet when the output packet requires transport identifier translation.

23. The method of claim 22 further comprising:
translating the received packet when the received packet requires transport identifier translation.

24. The method of claim 23 wherein the transport identifier is an Internet Protocol address, Transmission Control Protocol port, User Datagram Protocol port, Internet Control Message Protocol query identifier, Internet Protocol header checksum, Transmission Control Protocol header checksum, or User Datagram Protocol header checksum.

25. An apparatus for application in a wired and/or wireless network comprising:
means for receiving a packet via a scalable ingress path;
means for determining whether the received packet requires transport identifier translation;
means for outputting the received packet stream to one or more ports via a scalable egress path.

26. The apparatus of claim 25 further comprising:
means for translating an output packet when the output packet requires transport identifier translation.

27. The apparatus of claim 26 further comprising:
means for translating the received packet when the received packet requires transport identifier translation.

28. The apparatus of claim 27 wherein the transport identifier is an Internet Protocol address, Transmission Control Protocol port, User Datagram Protocol port, Internet Control Message Protocol query identifier, Internet Protocol header checksum, Transmission Control Protocol header checksum, or User Datagram Protocol header checksum.

29. A computer-readable medium, encoded with data and instructions, such that when executed by a computer, the instructions causes the computer to:
receive a packet via a scalable ingress path;
determine whether the received packet requires transport identifier translation;
output the received packet stream to one or more ports via a scalable egress path.

30. The computer-readable medium of claim 29, the instructions further comprising:
translate an output packet when the output packet requires transport identifier translation.

31. The computer-readable medium of claim 30, the instructions further comprising:
translate the received packet when the received packet requires transport identifier translation.

32. The computer-readable medium of claim 31 wherein the transport identifier is an Internet Protocol address, Transmission Control Protocol port, User Datagram Protocol port, Internet Control Message Protocol query identifier, Internet Protocol header checksum, Transmission Control Protocol header checksum, or User Datagram Protocol header checksum.
